(19) United States
(12) Patent Application Publication
(10) Pub. No.: US 2011/0022704 A1
(43) Pub. Date: Jan. 27, 2011

(54) METHOD AND SYSTEM FOR COLLECTING INFORMATION ON A USER VISIT

(75) Inventors: Ning Duan, Beijing (CN); Ying Huang, Shanghai (CN); Pei Sun, Beijing (CN); Wei Sun, Beijing (CN); Jian Ming Zhang, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/826,753

(22) Filed: Jun. 30, 2010

(30) Foreign Application Priority Data
Jun. 30, 2009 (CN) 200910139803.4

(51) Int. Cl. G06F 15/173

(52) U.S. Cl. 709/224

(57) ABSTRACT

The present invention provides a computer implemented method and system for collecting information on a user visit for web analytics. An information collection module is sent to a client in response to a page opening request from the client. The information collection module is for collecting additional information on user visit of the client. Additional information on user visit and basic information on user visit of the client is obtained from a web service request. A web beacon request is generated based on the obtained information. The invention adopts a non-intrusive information collection manner that does not require modifying code of a web application and thus, is much simpler, feasible, and cost-effective than prior art. Further, centralized collection and management for the information on user visit can be implemented. Thus, it is more flexible and convenient for maintenance and optimization.

### CROSS-REFERENCE TO RELATED APPLICATIONS

This application claims priority under 35 U.S.C. §119 from Chinese Patent Application No. 200910139803.4, filed Jun. 30, 2009, the entire contents of which are incorporated herein by reference.

### TECHNICAL FIELD OF THE INVENTION

The present invention relates to the technical field of web analytics, and more particularly, relates to a method and system for collecting information on user visit for web analytics.

### BACKGROUND OF THE INVENTION

Web analytics technology evolves with the expeditious development of web applications. Web analytics services can provide a variety of analytic functions for website owners, and help website owners to improve the website's access conversion rate, return on investment (ROI) and economic benefits.

FIG. 1 shows an exemplary interface of a web analytics service based on a prior art. The web analytics service is provided by Google Analytics. As shown in FIG. 1, the Google Analytics can provide a variety of analytics service items to website owners, such as access statistics, navigation analytics, and target web page optimization, etc. Through these service items, website owners can know the total visit times, bounce rate, state about amount of recent visit, and how visitors found web contents, and etc, and besides, website owners can get suggestions on improving visitor experiences, which are provided by the web analytics services.

In the prior art web analytics technology, it is typically required to add a snippet of tracking code as web beacon, such as JavaScript code, in a web page required to be tracked. The code added in the web page is for collecting information on user visit of a visitor and sending it to an analytics service provider for processing. An example for the tracking code is shown as follows.

Example of Tracking Code:
<script type=”text/javascript”>
Var gaJsHost=((”https:”==document.location.protocol)?
”https://ssl”:”http://www.”);
//if the url protocl at the current position is https protocol,
//loading https://ssl.google-analytics.com/ga.js;
//otherwise, loading http://www.google-analytics.com/ga.js
Document.write(unescape(”%3Cscript src=‘” + gaJsHost
+”google-analytics.com/ga.js‘type=‘text/javascript‘%3E%3C/script%3E”));
//output the decoded code through an escape ( ) coded character string
</script>
<script type=”text/javascript”>
Var pageTracker=_gat.getTracker(”UA-XXXXXX-X”);
//specifying the account of the website owner whose web pages required to be
tracked
pageTracker.initData( );
// initialzing data
pageTracker.trackPageview( );
// sending web page tracking data to an analytics server
</script>

When the visitor requests to open a web page, the tracking code will be transmitted to the client with the web page data as requested. The tracking code performs collection of information on user visit relevant information and generates a web beacon request based on the collected information on user visit relevant information. FIG. 2 shows an example of a web beacon request. The exemplary web beacon request includes: web beacon header “http://www.google-analytics.com/_utm.gif”; an information field indicating the information on user visit, such as “utmn=6438280008” indicating id of tracking activity id, “utmh=www.sample.com” indicating the client single hostname, and “utmcs=UTF-8” indicating page coding, etc; and information such as web analysis account “utmac=UA-2035756-2” for web application. Then, the generated web beacon request is transmitted to the web analytics service provider for analysis and processing.

In a traditional web application, one web page implements one function, and thus tracking each function can be realized by adding a tracking code in a web page so as to track each page, thereby performing an effective web analytics.

With the development of web technology and the advent of the second generate Internet mode web 2.0, asynchronous JavaScript and XML (AJAX) has played an increasingly import role in web application, more and more functions are implemented by using AJAX call in web page. One application for one web page has gradually become a development trend.

FIG. 3 shows an example of Web 2.0 web application. In such Web 2.0 web application containing an AJAX call, a plurality of functions are implemented in one web page, i.e. one web page corresponds to one application, not corresponding to one function like a traditional web application. For example, the pop-up box as shown in FIG. 3 is a pop-up box within a web page, not a new web page like in a traditional technology. Just for this reason, a web analytics technology applicable to a traditional web application can not implement tracking a plurality of functions performed within one web page by tracking the loading of a web page.

To solve this problem, there are mainly two technical solution in the prior art. One technical solution is to add a special tracking code before each AJAX call in a web page code. For example, for a Google Analytics service, the following tracking code may be added before each AJAX call:

Pagetraker._trackPageview(“/ajax/action1”)

//sending the tracking data to the Google Analytics server

so as to compulsively generate a web beacon request and send it to the web analytics service provider before calling the AJAX.

The other technical solution is code refactoring, i.e., modifying the AJAX framework so as to add a tracking code in a standardized manner, instead of manually adding a tracking code before each AJAX call of the web page code.

Both of the above two solutions can implement tracking the functions performed by AJAX call in a web page. However, they need to modify the web page's source code, i.e. it is an intrusive solution, which thus has some problems in practical application.

For the first technical solution, the fact that only when a web application owner owning the code of web application can modify the code, makes it impractical to some owners who are only responsible for managing and operating the web application. Further, whether the owner amends the code of web application himself or has another professional amend it, a considerable cost is required.

For the second technical solution, modifying AJAX framework will cause problems when upgrading the AJAX framework, because during upgrading the AJAX framework, it is necessary to further adjust the previous modification to the AJAX framework so as to adapt to the upgraded AJAX framework. However, such adjustment requires quite professional knowledge and skills. Moreover, such amendment also wastes time and energy.

Besides, the above two solutions have problems of poor adaptability and high maintaining cost. Both of the above two solutions require modification to the code of web application, thus once the demand on web analytics changes, the demand can only be satisfied by modifying the code of web application, which wastes considerable manpower and material resources, thus they have poor adaptability. Moreover, the codes inserted before AJAX call are scattered in the codes of the whole web application, they are not easy to manage and their maintaining cost is also considerable.

### SUMMARY OF THE INVENTION

In view of the above, the present invention provides a technical solution of collecting information on user visit for web analytics. The solution can at least partially eliminate or ameliorate the above defects or a part of the defects.

According to an aspect of the present invention, there is provided a method for collecting information on user visit for web analytics. The method may include: sending, in response to a page opening request from a client, an information collection module to the client, wherein the information collection module is for collecting additional information on user visit of the client; obtaining from a web service request the additional information on user visit and basic information on user visit of the client; generating a web beacon request based on the obtained additional information on user visit and basic information on user visit. Preferably, step of obtaining the additional information on user visit from the web service request and basic information on user visit of the client may include obtaining the additional information on user visit and basic information on user visit of the client from a hypertext transfer protocol request received from a server.

According to another aspect of the present invention, there is provided a system for collecting information on user visit for web analytics. The system may include: module sending means, for sending, in response to a page opening request from a client, an information collection module to the client, wherein the information collection module is for collecting additional information on user visit of the client; information obtaining means for obtaining from a web service request the additional information on user visit and basic information on user visit of the client; request generating means for generating a web beacon request based on the obtained additional information on user visit and basic information on user visit.

According to a further aspect of the present invention, there is provided a computer program product. The computer product has a computer program code, which, when running on the computer, is capable of implementing steps of the method of collecting information on user visit according to the present invention.

According to the method and system of the present invention, a web beacon request is generated by obtaining the additional information on user visit and basic information on user visit of the client from a web service request, not the case that the information on user visit is collected by modifying the code of web application. Thus, the present invention adopts a non-intrusive information collection manner. To this end, compared with the prior art of implementing collection of information on user visit by modifying the code of web application, the manner of collecting information on user visit according to the present invention is much simpler, easier to implement, and costs less, which is thus cost-effective. Moreover, in the preferred embodiments according to the present invention, centralized collection and management for information on user visit is implemented, thus the solution for information collection according to the present invention is more convenient for maintenance and optimization, and is also more flexible.

### BRIEF DESCRIPTION OF THE DRAWINGS

FIG. 1 shows an exemplary interface of a web analytics service according to the prior art;

FIG. 2 shows an example of web beacon request according to the prior art;

FIG. 3 shows an example of Web 2.0 web application;

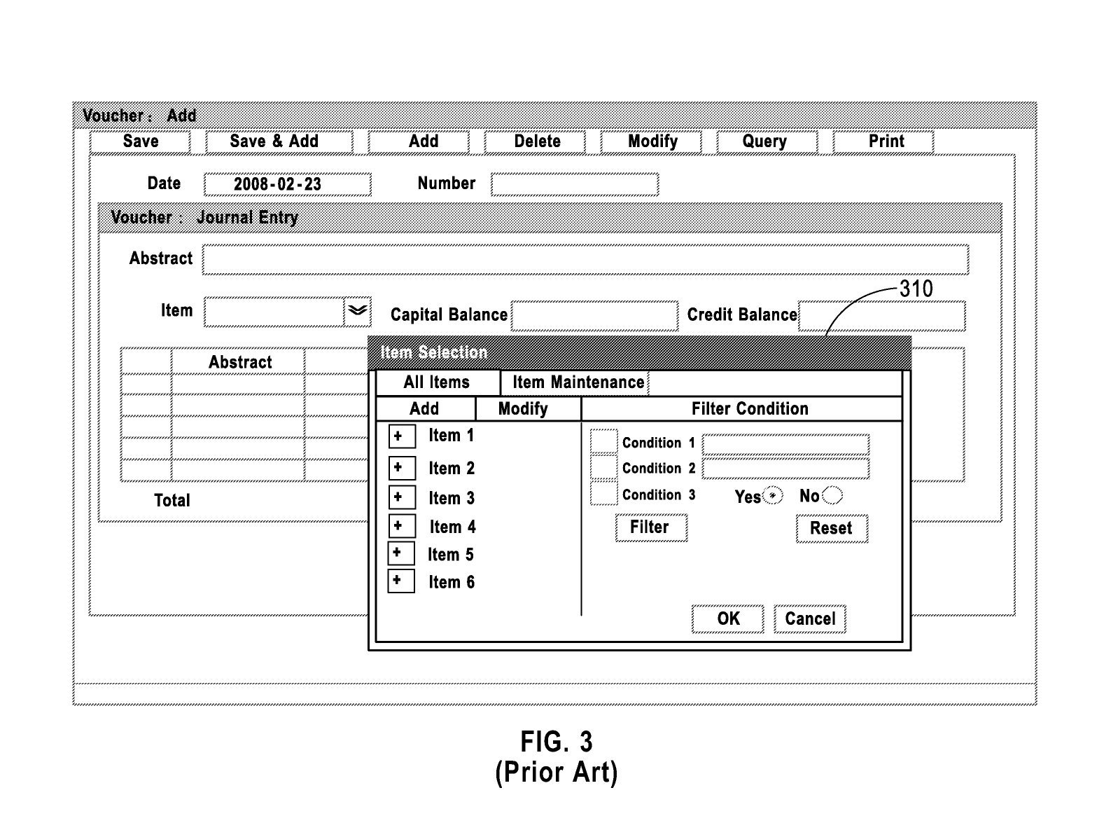

FIG. 4 shows a flow chart of a method for collecting information on user visit according to an embodiment of the present invention;

FIG. 5 shows a block diagram of a system for collecting information on user visit according to an embodiment of the present invention;

FIG. 6 shows a block diagram of a system for collecting information on user visit according to another embodiment of the present invention; and

FIG. 7 schematically shows a block diagram of a computer device capable of implementing therein embodiments according to the present invention.

### DETAILED DESCRIPTION OF THE PREFERRED EMBODIMENTS

Hereinafter, a method and system for collecting information on user visit as provided by the present invention will be described in detail through embodiments with reference to the accompanying drawings.

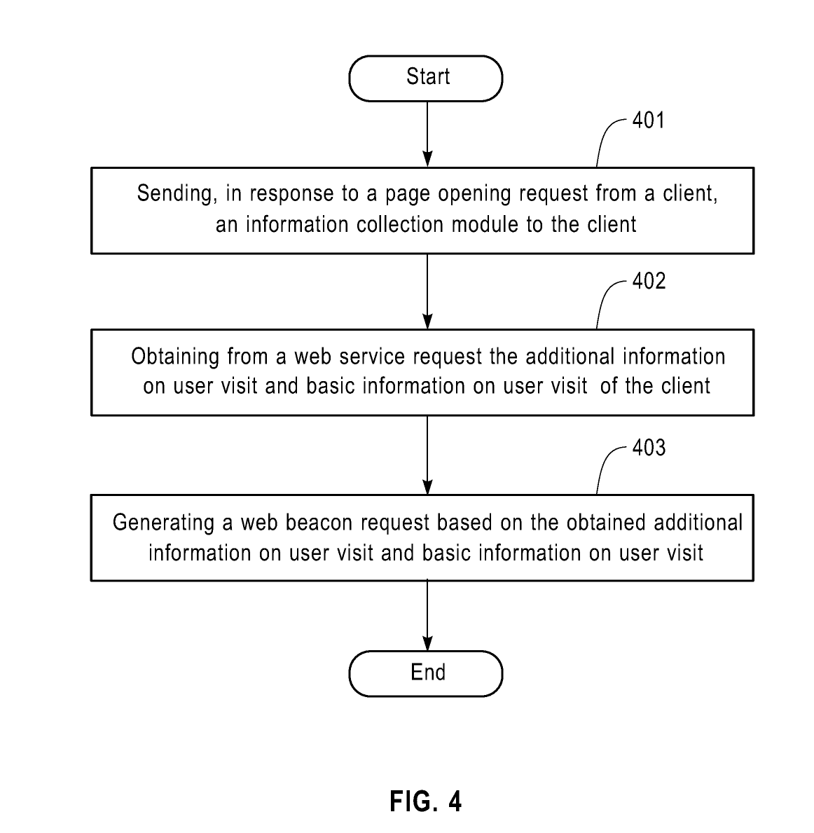

Firstly, a method according to an embodiment of the present invention will be described with reference to FIG. 4. FIG. 4 shows a flow chart of a method for collecting information on user visit according to an embodiment of the present invention.

As shown in FIG. 4, at step 401, in response to a page opening request from a client, an information collection module is sent to the client.

Like a common web request, AJAX call is also a HTTP request. The HTTP request includes information automatically collected by a browser. By parsing the HTTP request, information on user visit can be obtained, such as client internet protocol (IP) address, name of server site, visit time, request type and URL, reference information (from which URL the user clicks the link of the web site), user agent information, and etc. Such information on user visit can be used for web analytics. Based on such information, web analytics can be performed on for example region distribution of web visitors, peak period for web visit, information about visiting each function of the web application, from which URL links the user accesses the present web application, user's browser information, and OS information, etc. Thus, such information on user visit is enough to some common web analytics services. Thus, the present invention considers collecting information on user visit by obtaining information on user visit of the client from a web visit request. Besides, by parsing the response to a HTTP request, information such as response state, number of bytes returned from the service to the client, etc, based on which information further statistics to valid visit, invalid visit and visit traffic may be further performed.

Further, under the condition that the server of web application uses the browser's cookie to maintain a session, the corresponding code of web application also includes relevant cookie in the HTTP request, in which generally is included information on user visit, such as visitor identifier, session identifier, and visit times, etc. Thus, under this condition, it is possible to obtain the information on user visit in the above-mentioned cookie.

Besides the above basic information on user visit, the information on user visit may also include additional information on user visit. The additional information on user visit may be collected at the client by an information collection module. However, it should be noted that using an information collection module for information collection is a preferred embodiment of the present invention. Under the condition that it is not necessary to collect the additional information on user visit, the information collection module will not be required.

According to a preferred embodiment of the present invention, in response to the client's page opening request, the information collection module of for example a JavaScript code is downloaded to the client together with the page data. The information collection module is for collecting additional information on user visit of the client, for example, whether the client supports JavaScript, whether the client supports Flash, the operation system used by the client, the client's screen resolution, or other additional information on user visit that can be used for web analytics. The information collection module may also be responsible for computing, generating, and collecting more advanced information, for example it can, in lieu of the web application, be responsible for computing and generating the information which otherwise would be included by the web application in the Cookie, for example information on user visit such as visitor identifier, client session identifier, and visit times.

The collected additional information on user visit may be transmitted to a server with the HTTP request. In an embodiment of the present invention, a browser plug-in may be installed in the client, such that the collected additional information on user visit is attached to the HTTP request to be transmitted to the server, or in response to transmitting the HTTP request, the collected additional information on user visit is separately sent to the server.

However, in a preferred embodiment, the information collection module places the collected information on user visit in the cookie of the client. It is known that cookie will be automatically sent to the server through each HTTP request, thus the information on user visit collected by the information collection module will be sent to the server with the HTTP request. Compared with the above described manner of sending additional information on user visit, this manner is much easier and more feasible to be implemented and does not require the client to be installed with browser plug-ins.

From the above description, it is seen that the information collection module in the above embodiment of the present invention is different from the current tracking code. After collecting information on user visit of the client, the information collection module according to the above embodiment of the present invention is not responsible for generating and sending the web beacon request, but directly providing to the server the collected information on user visit of the client.

Next, at step 402, the additional information on user visit and basic information on user visit of the client is obtained from the web service request. In an embodiment according to the present invention, a hypertext transfer protocol (HTTP) request of the web browser from the client is obtained at the server of web application, and basic information on user visit and additional information on user visit of the client are obtained from the HTTP request by parsing the HTTP request.

Furthermore, in a preferred embodiment of the present invention, the HTTP request required to be tracked can be identified at the server by using a filter policy, and the additional information on user visit and basic information on user visit is parsed from the HTTP request required to be tracked.

According to an embodiment of the present invention, the HTTP request sent from the client to the server can be intercepted in real time, or alternatively, the HTTP request from the client is obtained from the server's web log. Subsequently, the HTTP request required to be tracked may be identified based on the predetermined filter policy.

In an embodiment of identifying the HTTP request required to be tracked based on a filter policy, the function required to be tracked can be identified based on a uniform resource locator (URL). It is known that different URLs correspond to different functions. Thus, a URL which is required to be tracked or a URL which is not required to be tracked may be stored in a system configuration file or a configuration table, such that only the HTTP request related to the function in the website owner's interest is obtained based on the information. In this case, the change of user's demand on web analytics can be adaptable by simply setting and changing the URL in the configuration file.

In another embodiment of identifying a HTTP request required to be tracked based on the filter policy, the HTTP requests which are not required to be tracked can be filtered off based on the client's IP address, so as to identify the HTTP requests which are required to be tracked. For example, the website owner may debug his own web site, and such debugging will incur HTTP requests. However, such HTTP requests do not represent a real user visit. Thus, to make the web analytics result more realistic, the website owner may not wish tracking the HTTP requests generated by debugging. In this case, the client IP address which is not be required to be tracked can be set, for example, the website owner's IP address, so as to filter off the HTTP requests which are not required to be tracked from the HTTP request.

In a further embodiment of identifying a HTTP request which is required to be tracked based on a filter policy, some HTTP requests which are not required to be tracked can be filtered off based on user agent information. For example, for searching a web site through a search engine, it is not a real website visit, thus HTTP requests related to this may be filtered off. If a HTTP request involves a fake visit related to the search engine, the user agent information in the HTTP request will be a value such as “google”. Thus, by setting the user agent information value which needs to be filtered off, such as “google”, “baidu”, etc, some HTTP requests which are not required to be tracked can be eliminated. In this way, the web analytics result can be more realistic.

It should be noted that, one or more of such filter policies can be used as required, and other proper filter policies can also be used as required.

Next, further refer to FIG. 4, at step 403, a web beacon request is generated by the obtained additional information on user visit and basic information on user visit.

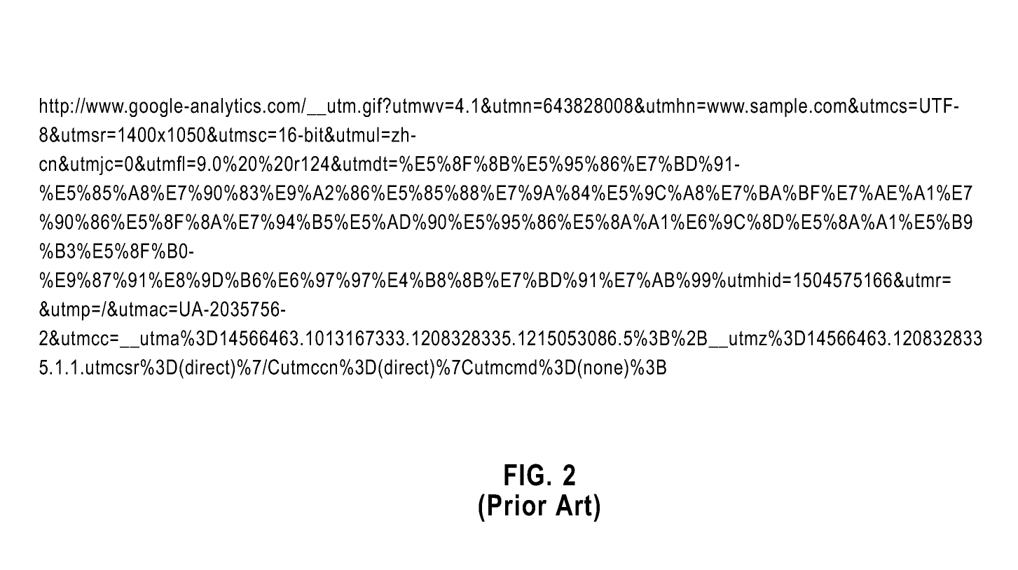

After obtaining the basic information on user visit and the additional information on user visit, a web beacon request may be generated based on such obtained information on user visit. According to an embodiment of the present invention, each piece of information can be retrieved from such obtained information on user visit, such as the client's IP address, name of the server site, the request type and URL, etc, and as required by the web service provider, the each piece of information is placed at a corresponding position in the request message, respectively, thereby generating a web beacon request. The generated web beacon request may be shown for example in FIG. 2. It is already known to generate a web beacon request based on such information on user visit, which will not be detailed here.

In specific applications, there may be some situations in which it is necessary to send the generated web beacon request to a plurality of web analytics servers for analysis, or it is necessary to change the web analytics service provider for providing web analytics services, or the information format as required by the web service provider changes. Under such situations, preferably, the obtained additional information on user visit and basic information on user visit may be further converted into a format as required by the web analytics server, such that the web beacon request is generated based on the converted additional information on user visit and basic information on user visit. Based on the embodiment, it is not necessary for the website owner to define an information format for a specific web analytics server, and instead the website owner can use a self-defined general format.

Under this condition, format conversion can be performed based on the correspondence relationship between the general format of the present invention and the format required by the web analytics service provider, so as to convert such information on user visit into the format as required by the web analytics service provider, such that the generated web beacon request can be set to a plurality of web analytics servers for analysis. According to the method of the present invention, a plurality of sets of correspondence relationship can be set to describe correspondences of the general format to the formats as required by different web analytics service providers, and besides, the service provider which provides web analytics services thereto can be selected and changed as required. Moreover, under the condition that the information format as required by the web service provider changes, such change can be adapted to quickly by performing the conversion. Thus, in this sense, the present embodiment has greater flexibility.

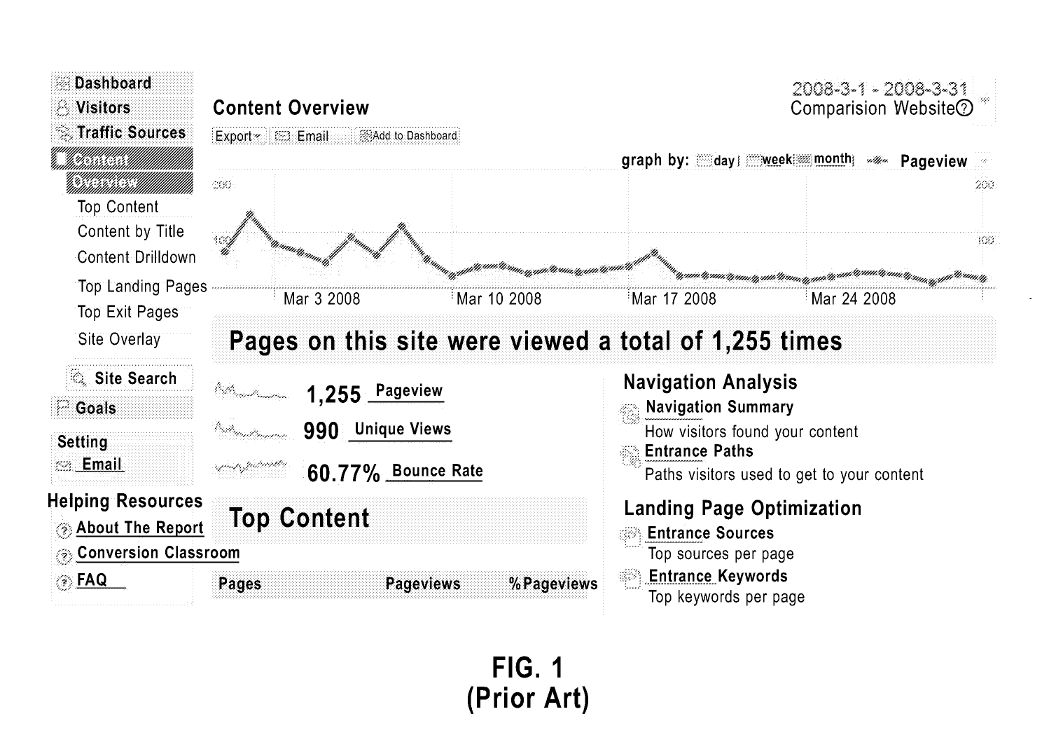

Next, such information format conversion will be described with reference to an instance. FIG. 1 exemplarily shows the correspondence relationships between the website owner's custom information format and the information format as required by the web analytics service provider.

TABLE 1
Correspondences between the custom information
format and the required information format

| Self-defined | Required | |
|---|---|---|
| information | information | |
| field | field | description |
| Trackid | _utmn | Randomly generated track activity id |
| Pgcode | _utmcs | Page code |
| Screen | _utmsr | Screen resolution |
| Color | _utmsc | Screen color quality, unit: bit |
| Browser | _utmul | Preference langaue of browser |
| Javasup | _utmje | Whether to support java |
| Flasv | _utmfl | Version number of client's flash plug-in |
| pagetitle | _utmdt | Title content of the page |
| hostname | _utmhn | Hostname of the client |
| currentP | _utmp | Page address of the client |
| previousP | _utmr | URL of the page immediately |
| | | preceding the current page, “0” if no |
| Domain | _utma:num1 | User's domain information |
| Uid | _utma:num2 | User's unique ID |
| cookietime | _utma:num3 | Creation time of Cookie |
| lasttime | _utma:num4 | Starting time of the last visit |
| currenttime | _utma:num5 | Starting time of the current visit |

Hereinafter, an instance of collected information on user visit is provided:

Instance of information on user visit:

GET/_message.gif?trackid=811050252&pgcode=gb2312&screen=1024x768&color
=32&browser=zh-cn&javasup=1&flasv=9.0&pagetitle=my%20title&hostname=127.0
.0.1&currentP=/WebSession/samplepage.html&domain=14566463&uid=101316733
3&cookietime=1208328335&lastTime=1215052821

From the above instance of information on user visit, it is seen that the collected information on user visit uses the information indicated by the fields in the first column of table 1, for example “trackid=811050252”, “pgcode=gb2312”, “screen=1024×768”, and etc. However, in order to generate a web beacon request in conformity with the service provider's format (as shown in the second column in table 1), it is necessary to convert such collected information on user visit, for example, converting “trackid=811050252” into “utmn=811050252”; converting “pgcode=gb2312” into “utmcs=gb2312”; and converting “screen=1024×768” into “utmsr=1024×768”. Besides, it is also possible that the field content per se can not meet the requirement of the service provider, for example, for the information on user visit “color=32”, where the field content as required by the service provider is “32-bit”. Under this condition, beside the correspondence of fields, it is also required to perform field content conversion. Such content conversion can be implemented through some conversion functions. After conversion, “color=32 is converted into “utmsc=32-bit”. On the other side, under the condition that the custom field content is “32-bit” while the field content as required by the service provider is “32”, it is also necessary to delete “-bit” in “32-bit” so as to perform conversion of content format. Similar content conversion can also be performed under the condition that other field contents can not satisfy the service provider's requirements. Based on the disclosure here, the skilled in the art can easily implement the above content format conversion, which is thus not detailed here.

The web beacon request generated based on the converted information on user visit is shown as follows:

Generated web beacon request:

http://www.google-analytics.com/_utm.gif?utmn=811050252&utmcs=gb2312&utm
sr=1024x768&utmsc=32-bit&utmul=zh-cn&utmje=1&utmfl=9.0&utmdt=my%20title&
utmhn=127.0.0.1&utmr=-&utmac=UA-2035756-2&utma=14566463.1013167333.12
08328335.1215052821.5&utmp=/Sales/action.do

The generated web beacon request, besides the converted information on user visit, also includes a web beacon header “http://www.google-analytics.com/_utm.gif”, a web analytics account “utmac=UA-2035756-2” of web application, and “utmp=/Sales/action.do” obtained from the AJAX request to indicate that the current request is AJAX request. Such information is all added to satisfy the web service provider's requirements.

Besides, preferably, the uniform resource locator in the obtained information on user visit can be mapped to the website owner's information format. It is known that a URL corresponds to a special function. Thus, in the preferred embodiment, a mapping of a URL to a corresponding function may be established, based on which the URL may be mapped to a corresponding function. Accordingly, what is included in the generated web beacon request is a function corresponding to the URL, not the URL per se which is not easily to comprehend. Accordingly, what is cited in the web analytics report provided to the website owner can be the function corresponding to the URL, such that the analytics report is more comprehensible and readable.

The generated web beacon request may be sent to the web analytics server directly or through other intermediate network entity for web analytics. However, it should be noted that though a web beacon request can be sent to the web analytics server immediately after its generation, the generated web beacon request can also be sent in a predetermined time interval, or based on other predetermined policy. Further, it is also possible that the server of web application directly performs web analytics based on the web beacon request, without sending it to the web analytics server.

In the prior art, an intrusive manner is adopted in collecting information on user visit, i.e. to implement collection of information on user visit for Web 2.0 based web application by adding a tracking code to each AJAX call of web application. However, from the above description of various embodiments of the present invention, it is seen that the method according to the present invention does not require modifying the code per se of the web application, which is thus a non-intrusive information collection manner. Compared with the prior art information on user visit collection manner, the present manner is much simpler, more feasible, and cost-effective.

Furthermore, in the prior art, the tracking codes added in web application codes are dispersed within the whole application, which are hard to maintain and have poor adaptability. However, in the preferred embodiments of the method according to the present invention, the information on user visit is obtained at the server, thereby realizing centralized collection and management on the information on user visit. Thus, compared with the prior art, the present method is more convenient for maintenance and optimization and also have greater adaptability and flexibility.

Besides, it should be noted that the above steps 401, 402, and 403 can be implemented on any server of a website or web application, as long as the HTTP request can be obtained, for example, an application server or a web server, but the present invention is not limited to this.

In another embodiment of the present invention, a web entity inside the server can obtain in real time the information on user visit in the HTTP request from the server, or obtain the web log from the server and obtain the information on user visit by parsing the web log. However, the information on user visit may be sent to a third party web entity which performs the steps of generating and sending a web beacon request.

Furthermore, In a further embodiment of the present invention, a third party web entity can obtain in real time the information on user visit in the HTTP request from the server, or obtain the web log from the server and obtain the information on user visit by parsing the web log. Subsequently, generating and sending a web beacon request are still performed by the third party web entity.

Further, it should be noted that though the present invention has described above with reference to the embodiments of obtaining the client's information on user visit from the server, the present invention is not limited thereto, and the web service request can also be obtained from any concerned web entity capable of obtaining the web service request from which it can obtain information on user visit of the client. For example, the web service request sent from the client can be intercepted by configuring a browser plug-in at the client, and then a corresponding web beacon request is generated based on the obtained information on user visit so as to send it to the web analytics server. Besides, the web visit request can also be intercepted at an intermediary web entity between the client and the server, so as to obtain information on user visit of the client.

Still further, it should be noted that though in the above description, the present invention is described with reference to the situation that the client uses a HTTP request to visit the server, the present invention is not limited thereto, and the information on user visit can also be obtained from other web service request. For example, under the condition that the client visits the client through FTP or TFTP, the information on user visit can be obtained from the FTP or TFTP request for web analytics.

Through description of the principle and embodiments of the present invention, the skilled in the art can easily apply them to the above conditions, which will not be detailed here.

Further, it should be noted that without going against the basic principle of the present invention, the above various embodiments can be combined in any proper way according to practical application.

Besides, it should also be noted that though the method and system of the present invention have been described with reference to the Web 2.0 based application, the present invention is not limited thereto. From the above description, the skilled in the art can understand that the method of the present invention may likewise be applied in a traditional web application. When the method of the present invention is applied to a traditional web application, it is also simple and feasible. Besides, it can also implement centralized collection and management, and thus is convenient for maintenance and optimization, and meanwhile it has a greater adaptability and flexibility.

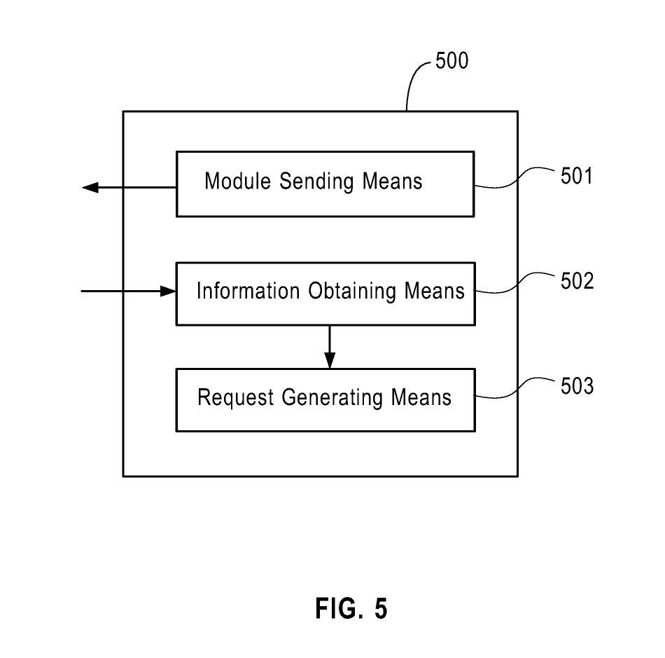

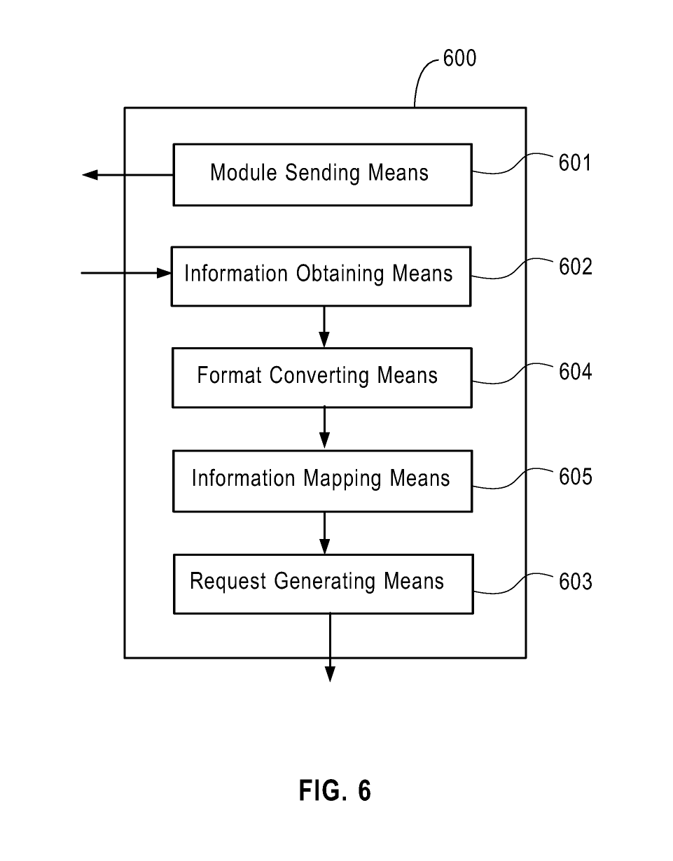

Hereinafter, a system for collecting information on user visit according to the present invention will be described with reference to FIGS. 5 and 6.

Firstly, reference is made to FIG. 5 which shows a system 500 for collecting information on user visit according to an embodiment of the present invention. As shown in FIG. 5, the system 500 may include module transmitting means 501 for sending, in response to a page opening request from a client, an information collection module to the client, wherein the information collection module is for collecting additional information on user visit of the client; information obtaining means 502 for obtaining additional information on user visit and basic information on user visit of the client from a web service request; and request generating means 503 for generating a web beacon request from the obtained additional information on user visit and basic information on user visit.

According to a preferred embodiment of the present invention, the collected additional information on user visit is placed in a Cookie such that it can be sent to a server with a hypertext transfer protocol request.

According to another preferred embodiment of the present invention, the information obtaining means 502 may be further configured to obtain additional information on user visit and basic information on user visit of the client from the web service request by obtaining additional information on user visit and basic information on user visit of the client from the hypertext transfer protocol request received from a server.

According to an embodiment of the present invention, the information obtaining means 502 may be configured to obtain the hypertext transfer protocol request which is required to be tracked from the server, and parse out the additional information on user visit and basic information on user visit from the hypertext transfer protocol request which is required to be tracked, so as to obtain additional information on user visit and basic information on user visit of the client from the hypertext transfer protocol request received from the server.

According to an another embodiment of the present invention, the information obtaining means 502 may be configured to obtain from the server a hypertext transfer protocol request which is required to be tracked by intercepting the hypertext transfer protocol request in real-time and identifying the hypertext transfer protocol required to be tracked.

According to a further embodiment of the present invention, the information obtaining means 502 may be configured to obtain a hypertext transfer protocol request which is required to be tracked from the server by obtaining from a web log the hypertext transfer protocol request and identifying the hypertext transfer protocol request which required to be tracked.

According to a still further embodiment of the present invention, the hypertext transfer protocol request which is required to be tracked may be identified through one or more information of a URL, a client IP address, and user agent information.

Next, reference is made to FIG. 6 which shows a system 600 for collecting information on user visit according to a yet further embodiment of the present invention. The system 600 may include: module sending means 601 corresponding to the module sending means 501 as shown in FIG. 5 and for sending, in response to a page opening request from a client, an information collection module to the client, wherein the information collection module is for collecting the additional information on user visit of the client; information obtaining module 602 corresponding to the information obtaining means 502 as shown in FIG. 5 and for obtaining additional information on user visit and basic information on user visit of the client from a web service request; and request generating means 603 which is corresponding to the request generating means 503 as shown in FIG. 5 and for generating a web beacon request based on the obtained additional information on user visit and basic information on user visit.

Different from the system 500 as shown in FIG. 5, the system 600 may further include format converting means 604 for converting the obtained additional information on user visit and basic information on user visit into a format as required by the web analytics server. Further preferably, the system 600 may further include information mapping means 605 for mapping a uniform resource locator in the obtained additional information on user visit and basic information on user visit to an information format for the website owner, wherein the web beacon request is generated based on the mapped additional information on user visit and basic information on user visit.

For the detailed operations of the module sending means 501, 601, information obtaining means 502, 602, request generating means 503, 603, format conversion means 604, and information mapping means 605, please refer to the above detailed description on the method of the present invention with reference to FIG. 4.

The system according to the present invention is a non-intrusive information collection system. Compared with the prior art, it is much simpler, more feasible and cost-effective. Besides, based on the preferred embodiments of the system according to the present invention, centralized collection and management on information on user visit can also be realized, and thus it is more convenient for maintenance and optimization and also more flexible.

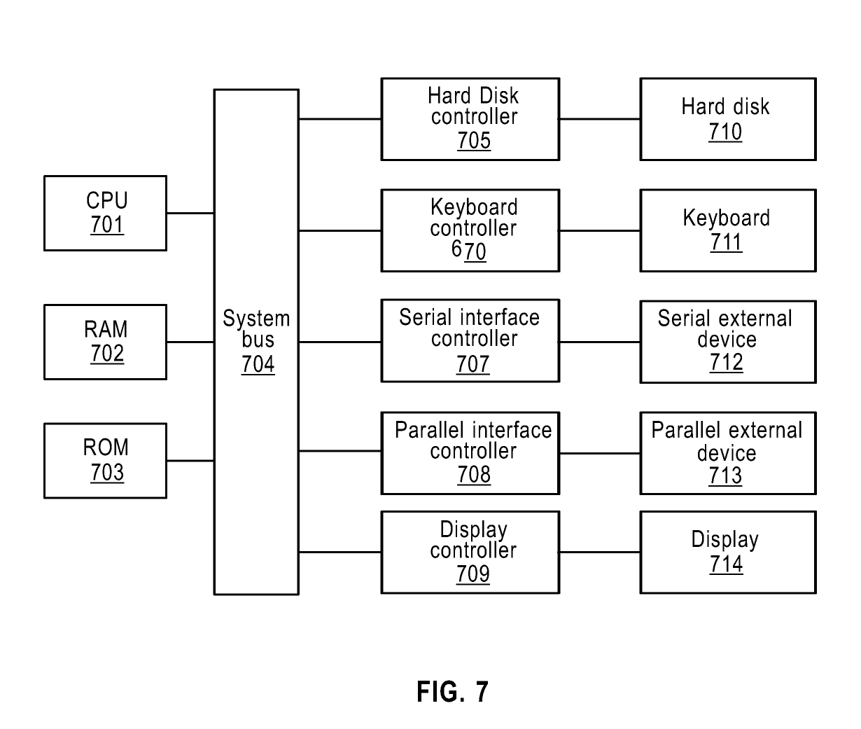

Hereinafter, a computer device which may implement the present invention is described with reference to FIG. 7. FIG. 7 schematically shows a structural block diagram of a computer device which may implement embodiments according to the present invention.

The computer system as shown in FIG. 7 includes a CPU (Central Processing Unit) 701, a RAM (Random Access Memory) 702, a ROM (Read Only Memory) 703, a system bus 704, a hard disk controller 705, a keyboard controller 706, a serial interface controller 707, a parallel interface controller 708, a display controller 709, a hard disk 710, a keyboard 711, a serial peripheral device 712, a parallel peripheral device 713 and a monitor 714. Among these components, connected to the system bus 704 are the CPU 701, the RAM 702, the ROM 703, the hard disk controller 705, the keyboard controller 706, the serial interface controller 707, the parallel controller 708, and the display controller 709. The hard disk 710 is connected to the hard disk controller 705; the keyboard 711 is connected to the keyboard controller 706; the serial peripheral device 712 is connected to the serial interface controller 707; the parallel peripheral device 713 is connected to the parallel interface controller 708; and the monitor 714 is connected to the monitor controller 709.

The structural block diagram in FIG. 7 is shown only for illustration purpose, and is not intended to limit the invention. In some cases, some devices can be added or reduced as required.

Further, the embodiments of the present invention can be implemented in software, hardware or the combination thereof. The hardware part can be implemented by a special logic; the software part can be stored in a memory and executed by a proper instruction execution system such as a microprocessor or a dedicated designed hardware.

While the present invention has been described with reference to the embodiments of the present invention considered by far, it should be understood that the invention is not limited to the embodiments disclosed herein. On the contrary, all modifications and equivalent arrangements that come within the spirit and range of the appended claims are intended to be embraced therein. The scope of the appended claims is accorded with the broadest interpretation to encompass all such modifications and equivalent structures and functions.

What is claimed is:

1. A computer implemented method for collecting information on a user visit, comprising:
sending, in response to a page opening request from a client, an information collection module to the client, wherein the information collection module is for collecting additional information on user visit of the client;
obtaining from a web service request the additional information on user visit and basic information on user visit of the client; and
generating a web beacon request based on the obtained additional information on user visit and basic information on user visit.

2. The method according to claim 1, wherein the collected additional information on user visit is placed in a Cookie, so as to be sent to a server with a hypertext transfer protocol request.

3. The method according to claim 1, wherein the step of obtaining from the web service request the additional information on user visit and basic information on user visit of the client, further comprises:
obtaining the additional information on user visit and basic information on user visit of the client from a hypertext transfer protocol request received from a server.

4. The method according to claim 3, wherein the obtaining the additional information on user visit and basic information on user visit of the client from a hypertext transfer protocol HTTP request received from the server further comprises:
obtaining a hypertext transfer protocol HTTP request which is required to be tracked from the server; and
parsing out the additional information on user visit and basic information on user visit from the hypertext transfer protocol request which is required to be tracked.

5. The method according to claim 4, wherein the obtaining the hypertext transfer protocol request which is required to be tracked from the server comprises:
intercepting in real time the hypertext transfer protocol request; and
identifying the hypertext transfer protocol request which is required to be tracked.

6. The method according to claim 4, wherein the obtaining the hypertext transfer protocol request which is required to be tracked from the server comprises:
obtaining the hypertext transfer request from a web log; and
identifying the hypertext transfer protocol request which is required to be tracked.

7. The method according to claim 5, wherein the hypertext transfer protocol request which is required to be tracked is identified based on one or more of:
a uniform resource locator;
a client Internet protocol address; and
user agent information.

8. The method according to claim 6, wherein the hypertext transfer protocol request which is required to be tracked is identified based on one or more of:
a uniform resource locator;
a client Internet protocol address; and
user agent information.

9. The method according to claim 1, further comprising:
converting the obtained additional information on user visit and basic information on user visit into a format as required by a web analytics server,
wherein the web beacon request is generated based on the converted additional information on user visit and basic information on user visit.

10. The method according to claim 1, further comprising;
mapping the uniform resource locator in the obtained additional information on user visit and basic information on user visit into an information format for the website owner,
wherein the web beacon request is generated based on the mapped additional information on user visit and basic information on user visit.

11. A system for collecting information on a user visit, comprising:
module sending means for sending, in response to a page opening request from a client, an information collection module to the client, wherein the information collection module is for collecting additional information on user visit of the client;
information obtaining means for obtaining from a web service request the additional information on user visit and basic information on user visit of the client; and
request generating means for generating a web beacon request based on the obtained additional information on user visit and basic information on user visit.

12. The system according to claim 11, wherein the collected additional information on user visit is placed in a Cookie, so as to be sent to a server with a hypertext transfer protocol request.

13. The system according to claim 11, wherein the information obtaining means is further configured to obtain from the web service request the additional information on user visit and basic information on user visit of the client by obtaining from the hypertext transfer protocol request received from a server the additional information on user visit and basic information on user visit of the client.

14. The system according to claim 13, wherein the information obtaining means is further configured to obtain from the hypertext transfer protocol request received from the server the additional information on user visit and basic information on user visit of the client by:
obtaining a hypertext transfer protocol request which is required to be tracked from the server; and
parsing out the additional information on user visit and basic information on user visit from the hypertext transfer protocol request which is required to be tracked.

15. The system according to claim 14, wherein the information obtaining means is configured to obtain the hypertext transfer protocol request which is required to be tracked from the server by:
intercepting in real time the hypertext transfer protocol request; and
identifying the hypertext transfer protocol request which is required to be tracked.

16. The system according to claim 14, wherein the information obtaining means is configured to obtain from the server the hypertext transfer protocol request which is required to be tracked by:
obtaining the hypertext transfer request from a web log; and
identifying the hypertext transfer protocol request which is required to be tracked.

17. The system according to claim 15, wherein the hypertext transfer protocol request which is required to be tracked is identified based on one or more of:
a uniform resource locator;
a client internet protocol address; and
user agent information.

18. The system according to claim 16, wherein the hypertext transfer protocol request which is required to be tracked is identified based on one or more of:
a uniform resource locator;
a client internet protocol address; and
user agent information.

19. The system according to claim 11, further comprising:
format converting means for converting the obtained additional information on user visit and basic information on user visit into a format as required by the web analytics server,
wherein the web beacon request is generated based on the converted additional information on user visit and basic information on user visit.

20. The system according to claim 11, further comprising:
information mapping module for mapping the uniform resource locator in the obtained additional information on user visit and basic information on user visit to an information format for the website owner,
wherein the web beacon request is generated based on the mapped additional information on user visit related and basic information on user visit.

21. A computer readable article of manufacture tangibly embodying computer readable instructions which when executed causes a computer to carry out the steps of:
sending, in response to a page opening request from a client, an information collection module to the client, wherein the information collection module is for collecting additional information on user visit of the client;
obtaining from a web service request the additional information on user visit and basic information on user visit of the client; and
generating a web beacon request based on the obtained additional information on user visit and basic information on user visit.
